(19) United States
(12) Patent Application Publication
(10) Pub. No.: US 2008/0319726 A1
(43) Pub. Date: Dec. 25, 2008

(54) SYSTEM AND METHOD FOR PERFORMING OILFIELD SIMULATION OPERATIONS

(75) Inventors: Johan Gerhard Berge, Langhus (NO); Terizhandur S. Ramakrishnan, Boxborough, MA (US); Suzanne Jacqueline Hurter, The Hague (NL); Laurent Jammes, Paris (FR); Y. Bilgin Altundas, Somerville, MA (US); Kamel Bennaceur, Paris (FR); Murtaza Ziauddin, Katy, TX (US)

Correspondence Address: OSHA . LIANG L.L.P. / SLB, TWO HOUSTON CENTER, 909 FANNIN STREET, SUITE 3500, HOUSTON, TX, 77010, US

(73) Assignee: SCHLUMBERGER TECHNOLOGY CORPORATION, Houston, TX (US)

(21) Appl. No.: 12/141,805

(22) Filed: Jun. 18, 2008

Related U.S. Application Data
(60) Provisional application No. 60/936,461, filed on Jun. 19, 2007.

(51) Int. Cl. G06G 7/48

(52) U.S. Cl. 703/10

(57) ABSTRACT

The invention relates to a method of performing a gas operation of an oilfield having a subterranean formation with at least one reservoir positioned therein. The method steps include modeling the gas operation of the oilfield using a multi-domain simulator by coupling a static model of the subterranean formation, a dynamic model of the subterranean formation, and a well model, wherein the multi-domain simulator comprises the static model, the dynamic model, and the well model, defining a development plan for the gas operation based on the modeling, and performing gas injection according to the development plan.

### CROSS REFERENCE TO RELATED APPLICATIONS

This application claims priority under 35 U.S.C. §119(e) from Provisional Patent Application No. 60/936,461 filed Jun. 19, 2007.

### BACKGROUND OF THE INVENTION

1. Field of the Invention

The present invention relates to techniques for performing oilfield operations relating to subterranean formations having reservoirs therein.

More particularly, the invention relates to techniques for performing oilfield operations involving an analysis of reservoir, cap rock, overburden, and other geological structures in the subterranean formations, and their impact on such oilfield operations.

2. Background of the Related Art

Oilfield operations, such as surveying, drilling, wireline testing, completions, simulation, planning and oilfield analysis, are typically performed to locate and gather valuable downhole fluids. Various aspects of the oilfield and its related operations are shown in FIGS. 1A-1D. As shown in FIG. 1A, surveys are often performed using acquisition methodologies, such as seismic scanners to generate maps of underground structures. These structures are often analyzed to determine the presence of subterranean assets, such as valuable fluids or minerals. This information is used to assess the underground structures and locate the formations containing the desired subterranean assets. Data collected from the acquisition methodologies may be evaluated and analyzed to determine whether such valuable items are present, and if they are reasonably accessible.

As shown in FIG. 1B-1D, one or more wellsites may be positioned along the underground structures to gather valuable fluids from the subterranean reservoirs. The wellsites are provided with tools capable of locating and removing hydrocarbons from the subterranean reservoirs. As shown in FIG. 1B, drilling tools are typically advanced from the oil rigs and into the earth along a given path to locate the valuable downhole fluids. During the drilling operation, the drilling tool may perform downhole measurements to investigate downhole conditions. In some cases, as shown in FIG. 1C, the drilling tool is removed and a wireline tool is deployed into the wellbore to perform additional downhole testing.

After the drilling operation is complete, the well may then be prepared for simulation. As shown in FIG. 1D, wellbore completions equipment is deployed into the wellbore to complete the well in preparation for the simulation of fluid therethrough. Fluid is then drawn from downhole reservoirs, into the wellbore and flows to the surface. Simulation facilities are positioned at surface locations to collect the hydrocarbons from the wellsite(s). Fluid drawn from the subterranean reservoir(s) passes to the simulation facilities via transport mechanisms, such as tubing. Various equipment may be positioned about the oilfield to monitor oilfield parameters and/or to manipulate the oilfield operations.

During the oilfield operations, data is typically collected for analysis and/or monitoring of the oilfield operations. Such data may include, for example, subterranean formation, equipment, historical and/or other data. Data concerning the subterranean formation is collected using a variety of sources. Such formation data may be static or dynamic. Static data relates to, for example, formation structure and geological stratigraphy that define the geological structure of the subterranean formation. Dynamic data relates to, for example, fluids flowing through the geologic structures of the subterranean formation over time. Such static and/or dynamic data may be collected to learn more about the formations and the valuable assets contained therein.

Sources used to collect static data may be seismic tools, such as a seismic truck that sends compression waves into the earth as shown in FIG. 1A. These waves are measured to characterize changes in the density of the geological structure at different depths. This information may be used to generate basic structural maps of the subterranean formation. Other static measurements may be gathered using core sampling and well logging techniques. Core samples may be used to take physical specimens of the formation at various depths as shown in FIG. 1B. Well logging typically involves deployment of a downhole tool into the wellbore to collect various downhole measurements, such as density, resistivity, etc., at various depths.

Such well logging may be performed using, for example, the drilling tool of FIG. 1B and/or the wireline tool of FIG. 1C. Once the well is formed and completed, fluid flows to the surface using simulation tubing as shown in FIG. 1D. As fluid passes to the surface, various dynamic measurements, such as fluid flow rates, pressure, and composition may be monitored. These parameters may be used to determine various characteristics of the subterranean formation.

Sensors may be positioned about the oilfield to collect data relating to various oilfield operations. For example, sensors in the drilling equipment may monitor drilling conditions, sensors in the wellbore may monitor fluid composition, sensors located along the flow path may monitor flow rates, and sensors at the processing facility may monitor fluids collected. Other sensors may be provided to monitor downhole, surface, equipment or other conditions. The monitored data is often used to make decisions at various locations of the oilfield at various times. Data collected by these sensors may be further analyzed and processed. Data may be collected and used for current or future operations. When used for future operations at the same or other locations, such data may sometimes be referred to as historical data.

The processed data may be used to predict downhole conditions, and make decisions concerning oilfield operations. Such decisions may involve well planning, well targeting, well completions, operating levels, simulation rates and other operations and/or conditions. Often this information is used to determine when to drill new wells, re-complete existing wells, or alter wellbore simulation.

Data from one or more wellbores may be analyzed to plan or predict various outcomes at a given wellbore. In some cases, the data from neighboring wellbores or wellbores with similar conditions or equipment may be used to predict how a well will perform. There are usually a large number of variables and large quantities of data to consider in analyzing oilfield operations. It is, therefore, often useful to model the behavior of the oilfield operation to determine the desired course of action. During the ongoing operations, the operating conditions may need adjustment as conditions change and new information is received.

Techniques have been developed to model the behavior of various aspects of the oilfield operations, such as geological structures, downhole reservoirs, wellbores, surface facilities as well as other portions of the oilfield operation. Examples of these modeling techniques are shown in Patent/Publication/Application Nos. U.S. Pat. No. 5,992,519, WO2004/049216, WO1999/064896, WO2005/122001, U.S. Pat. No. 6,313,837, US2003/0216897, US2003/0132934, US2005/0149307, US2006/0197759, U.S. Pat. No. 6,980,940, US2004/0220846, and Ser. No. 10/586,283.

Techniques have also been developed for performing reservoir simulation operations. See, for example, Patent/Publication/Application Nos. U.S. Pat. No. 6,230,101, U.S. Pat. No. 6,018,497, U.S. Pat. No. 6,078,869, GB2336008, U.S. Pat. No. 6,106,561, US2006/0184329, U.S. Pat. No. 7,164,990. Some simulation techniques may involve an analysis of gas and its effects on the oilfield operation. See, for example U.S. Pat. No. 7,069,148. Some simulation techniques involve the use of coupled simulations as described, for example, in Publication No. US2006/0129366.

Despite the development and advancement of reservoir simulation techniques in oilfield operations, there remains a need to consider the effects of gas on oilfield operations. It would be desirable to provide techniques for selecting, planning and/or implementing gas operations based on static and dynamic aspects of the oilfield. It is further desirable that such techniques selectively consider desired parameters, such as chemistry, transport, mechanics and heat. Such desired techniques may be capable of one of more of the following, among others: providing modeling capability for a variety of subsurface formations (such as oil field, gas field, brine reservoir, aquifer, etc.), providing coupling capability of static model, dynamic model, etc. in the simulator, providing coupling capability among various physico-chemical mechanisms, providing feedback to permit adjustment of desired portions of the oilfield and/or gas operation, providing planning (i.e., development plan, operational plan, monitoring plan, etc.) based on simulation results.

### SUMMARY OF THE INVENTION

In general, in one aspect, the invention relates to a method of performing a gas operation of an oilfield having a subterranean formation with at least one reservoir positioned therein. The method steps include modeling the gas operation of the oilfield using a multi-domain simulator by coupling a static model of the subterranean formation, a dynamic model of the subterranean formation, and a well model, wherein the multi-domain simulator comprises the static model, the dynamic model, and the well model, defining a development plan for the gas operation based on the modeling, and performing gas injection according to the development plan.

In general, in one aspect, the invention relates to a method of performing a gas operation of an oilfield having a subterranean formation with at least one reservoir positioned therein. The method steps include modeling the gas operation of the oilfield using a multi-domain simulator by coupling a static model of the subterranean formation, a dynamic model of the subterranean formation, and a well model, wherein the multi-domain simulator comprises the static model, the dynamic model, and the well model, acquiring at least one selected from a group consisting of survey data and monitoring data from the subterranean formation, providing a feedback based on comparing simulation data from the multi-domain simulator to the at least one selected from a group consisting of survey data and monitoring data, and performing the gas operation according to the feedback.

In general, in one aspect, the invention relates to a method of performing a gas operation of an oilfield having a subterranean formation with at least one reservoir positioned therein. The method steps include modeling the gas operation of the oilfield using a multi-domain simulator by coupling a static model of the subterranean formation, a dynamic model of the subterranean formation, and a well model, wherein the multi-domain simulator comprises the static model, the dynamic model, and the well model, performing an economic assessment based on the modeling, and performing the gas operation according to the economic assessment.

In general, in one aspect, the invention relates to a computer readable medium, embodying instructions executable by a computer to perform method steps for a gas operation of an oilfield having a subterranean formation with at least one reservoir positioned therein. The instructions include functionality to model the gas operation of the oilfield using a multi-domain simulator by coupling a static model of the subterranean formation, a dynamic model of the subterranean formation, and a well model, wherein the multi-domain simulator comprises the static model, the dynamic model, and the well model, to define a development plan for the gas operation based on the modeling, and to perform gas injection according to the development plan.

In general, in one aspect, the invention relates to a computer readable medium embodying instructions executable by a computer to perform method steps for computer readable medium, embodying instructions executable by a computer to perform method steps for a gas operation of an oilfield having a subterranean formation with at least one reservoir positioned therein. The instructions include functionality to model the gas operation of the oilfield using a multi-domain simulator by coupling a static model of the subterranean formation, a dynamic model of the subterranean formation, and a well model, wherein the multi-domain simulator comprises the static model, the dynamic model, and the well model, to acquire at least one selected from a group consisting of survey data and monitoring data from the subterranean formation, to provide a feedback based on comparing simulation data from the multi-domain simulator to the at least one selected from a group consisting of survey data and monitoring data, and to perform the gas operation according to the feedback.

Other aspects and advantages of the invention will be apparent from the following description and the appended claims.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D show exemplary schematic views of an oilfield having subterranean structures including reservoirs therein and various oilfield operations being performed on the oilfield. FIG. 1A depicts an exemplary survey operation being performed by a seismic truck. FIG. 1B depicts an exemplary drilling operation being performed by a drilling tool suspended by a rig and advanced into the subterranean formation. FIG. 1C depicts an exemplary wireline operation being performed by a wireline tool suspended by the rig and into the wellbore of FIG. 1B. FIG. 1D depicts an exemplary simulation operation being performed by a simulation tool being deployed from the rig and into a completed wellbore for drawing fluid from the downhole reservoir into a surface facility.

FIGS. 2A-2D are exemplary graphical depictions of data collected by the tools of FIGS. 1A-1D, respectively. FIG. 2A depicts an exemplary seismic trace of the subterranean formation of FIG. 1A. FIG. 2B depicts exemplary core sample of the formation shown in FIG. 1B. FIG. 2C depicts an exemplary well log of the subterranean formation of FIG. 1C. FIG. 2D depicts an exemplary simulation decline curve of fluid flowing through the subterranean formation of FIG. 1D.

FIG. 3 shows an exemplary schematic view, partially in cross section, of an oilfield having a plurality of data acquisition tools positioned at various locations along the oilfield for collecting data from the subterranean formation.

FIG. 4 shows an exemplary schematic view of an oilfield having a plurality of wellsites for producing oil from the subterranean formation.

FIG. 5 shows an exemplary schematic diagram of a portion of the oilfield of FIG. 4 depicting the simulation operation in detail.

FIG. 6 shows an exemplary schematic diagram of a gas operation having a site selection stage and a planning stage gas operation.

FIG. 7 shows the gas operation of FIG. 6 depicting a planning stage of the gas operation.

FIG. 8 shows an exemplary schematic diagram of the gas operation of FIG. 6 or 7 depicting an implementation stage of the gas operation.

FIG. 9 shows an exemplary schematic diagram of the gas operation of FIG. 8 depicting a risk assessment of the injection stage of the gas operation.

FIGS. 10A and 10B show schematic diagrams of a multi-domain simulation module. FIG. 10A depicts the dynamic model in greater detail. FIG. 10B depicts the multi-domain simulation module having a static model and a dynamic model.

FIGS. 11-12 show exemplary flow charts of a method for performing a gas operation.

### DETAILED DESCRIPTION OF THE INVENTION

Presently preferred embodiments of the invention are shown in the above-identified figures and described in detail below. In describing the preferred embodiments, like or identical reference numerals are used to identify common or similar elements. The figures are not necessarily to scale and certain features and certain views of the figures may be shown exaggerated in scale or in schematic in the interest of clarity and conciseness.

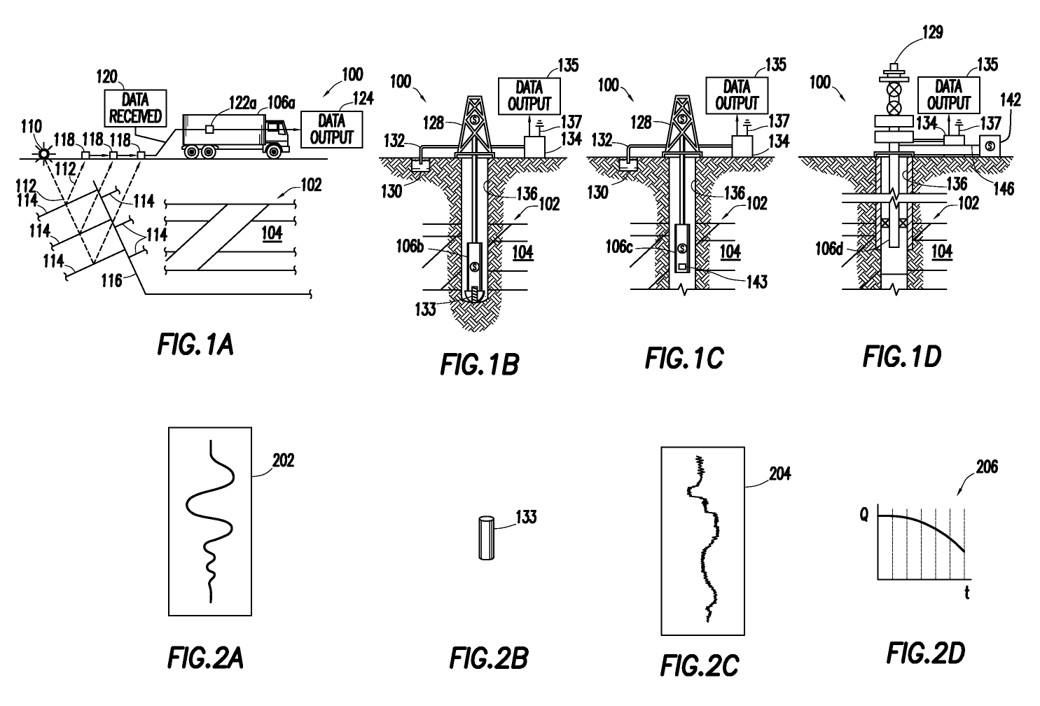

FIGS. 1A-D show an oilfield (100) having geological structures and/or subterranean formations therein. As shown in these figures, various measurements of the subterranean formation are taken by different tools at the same location. These measurements may be used to generate information about the formation and/or the geological structures and/or fluids contained therein. In addition, instruments placed at the surface may be used to detect and sample fluids (i.e., liquids and gases) migrating (e.g., leaking) to the surface from depth. These data can be introduced into a static and a dynamic model used to obtain information on the sealing capacity of the subterranean cap rock covering the reservoir of interest.

FIGS. 1A-1D depict schematic views of an oilfield (100) having subterranean formations (102) containing a reservoir (104) therein and depicting various oilfield operations being performed on the oilfield (100). FIG. 1A depicts a survey operation being performed by a seismic truck (106a) to measure properties of the subterranean formation. The survey operation is a seismic survey operation for producing sound vibrations. In FIG. 1A, one such sound vibration (112) is generated by a source (110) and reflects off a plurality of horizons (114) in an earth formation (116). The sound vibration(s) (112) is (are) received in by sensors (S), such as geophone-receivers (118), situated on the earth's surface, and the geophone-receivers (118) produce electrical output signals, referred to as data received (120) in FIG. 1.

In response to the received sound vibration(s) (112) representative of different parameters (such as amplitude and/or frequency) of the sound vibration(s) (112). The data received (120) is provided as input data to a computer (122a) of the seismic recording truck (106a), and responsive to the input data, the recording truck computer (122a) generates a seismic data output record (124). The seismic data may be further processed as desired, for example by data reduction.

FIG. 1B depicts a drilling operation being performed by a drilling tool (106b) suspended by a rig (128) and advanced into the subterranean formation (102) to form a wellbore (136). A mud pit (130) is used to draw drilling mud into the drilling tool (106b) via flow line (132) for circulating drilling mud through the drilling tool (106b) and back to the surface. The drilling tool (106b) is advanced into the formation to reach reservoir (104). The drilling tool (106b) is preferably adapted for measuring downhole properties. The drilling tool (106b) may also be adapted for taking a core sample (133) as shown or removed so that a core sample (133) may be taken using another tool.

A surface unit (134) is used to communicate with the drilling tool (106b) and offsite operations. The surface unit (134) is capable of communicating with the drilling tool (106b) to send commands to drive the drilling tool (106b), and to receive data therefrom. The surface unit (134) is preferably provided with computer facilities for receiving, storing, processing, and analyzing data from the oilfield (100). The surface unit (134) collects data output (135) generated during the drilling operation. Computer facilities, such as those of the surface unit (134), may be positioned at various locations about the oilfield (100) and/or at remote locations.

Sensors (S), such as gauges, may be positioned throughout the reservoir, rig, oilfield equipment (such as the downhole tool), or other portions of the oilfield for gathering information about various parameters, such as surface parameters, downhole parameters, and/or operating conditions. These sensors (S) preferably measure oilfield parameters, such as weight on bit, torque on bit, pressures, temperatures, flow rates, compositions and other parameters of the oilfield operation.

The information gathered by the sensors (S) may be collected by the surface unit (134) and/or other data collection sources for analysis or other processing. The data collected by the sensors (S) may be used alone or in combination with other data. The data may be collected in a database and all or select portions of the data may be selectively used for analyzing and/or predicting oilfield operations of the current and/or other wellbores.

Data outputs from the various sensors (S) positioned about the oilfield may be processed for use. The data may be historical data, real time data, or combinations thereof. The real time data may be used in real time, or stored for later use. The data may also be combined with historical data or other inputs for further analysis. The data may be housed in separate databases, or combined into a single database.

The collected data may be used to perform analysis, such as modeling operations. For example, the seismic data output may be used to perform geological, geophysical, reservoir engineering, and/or production simulations. The reservoir, wellbore, surface and/or process data may be used to perform reservoir, wellbore, or other production simulations. The data outputs from the oilfield operation may be generated directly from the sensors (S), or after some preprocessing or modeling. These data outputs may act as inputs for further analysis.

The data is collected and stored at the surface unit (134). One or more surface units (134) may be located at the oilfield (100), or linked remotely thereto. The surface unit (134) may be a single unit, or a complex network of units used to perform the necessary data management functions throughout the oilfield (100). The surface unit (134) may be a manual or automatic system. The surface unit (134) may be operated and/or adjusted by a user.

The surface unit (134) may be provided with a transceiver (137) to allow communications between the surface unit (134) and various portions of the oilfield (100) or other locations. The surface unit (134) may also be provided with or functionally linked to a controller for actuating mechanisms at the oilfield. The surface unit (134) may then send command signals to the oilfield (100) in response to data received. The surface unit (134) may receive commands via the transceiver or may itself execute commands to the controller. A processor may be provided to analyze the data (locally or remotely) and make the decisions to actuate the controller. In this manner, the oilfield (100) may be selectively adjusted based on the data collected to optimize fluid recovery rates, or to maximize the longevity of the reservoir and its ultimate production capacity. These adjustments may be made automatically based on computer protocol, or manually by an operator. In some cases, well plans may be adjusted to select optimum operating conditions, or to avoid problems.

FIG. 1C depicts a wireline operation being performed by a wireline tool (106c) suspended by the rig (128) and into the wellbore (136) of FIG. 1B. The wireline tool (106c) is preferably adapted for deployment into a wellbore (136) for performing well logs, performing downhole tests and/or collecting samples. The wireline tool (106c) may be used to provide another method and apparatus for performing a seismic survey operation. The wireline tool (106c) of FIG. 1C may have an explosive or acoustic energy source (143) that provides electrical signals to the surrounding subterranean formations (102).

The wireline tool (106c) may be operatively linked to, for example, the geophones (118) stored in the computer (122a) of the seismic recording truck (106a) of FIG. 1A. The wireline tool (106c) may also provide data to the surface unit (134). As shown data output (135) is generated by the wireline tool (106c) and collected at the surface. The wireline tool (106c) may be positioned at various depths in the wellbore (136) to provide a survey of the subterranean formation.

FIG. 1D depicts a production operation being performed by a production tool (106d) deployed from a production unit or Christmas tree (129) and into the completed wellbore (136) of FIG. 1C for drawing fluid from the downhole reservoirs into the surface facilities (142). Fluid flows from reservoir (104) through perforations in the casing (not shown) and into the production tool (106d) in the wellbore (136) and to the surface facilities (142) via a gathering network (146).

Sensors (S), such as gauges, may be positioned about the oilfield to collect data relating to various oilfield operations as described previously. As shown, the sensor (S) may be positioned in the production tool (106d) or associated equipment, such as the Christmas tree, gathering network, surface facilities and/or the production facility, to measure fluid parameters, such as fluid composition, flow rates, pressures, temperatures, and/or other parameters of the production operation.

While only simplified wellsite configurations are shown, it will be appreciated that the oilfield may cover a portion of land, sea and/or water locations that hosts one or more wellsites. Production may also include injection wells (not shown) for added recovery. One or more gathering facilities may be operatively connected to one or more of the wellsites for selectively collecting downhole fluids from the wellsite(s).

While FIGS. 1B-1D depict tools used to measure properties of an oilfield (100), it will be appreciated that the tools may be used in connection with non-oilfield operations, such as mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The oilfield configuration in FIGS. 1A-1D are intended to provide a brief description of an example of an oilfield usable with the present invention. Part, or all, of the oilfield (100) may be on land and/or sea. Also, while a single oilfield measured at a single location is depicted, the present invention may be utilized with any combination of one or more oilfields (100), one or more processing facilities and one or more wellsites.

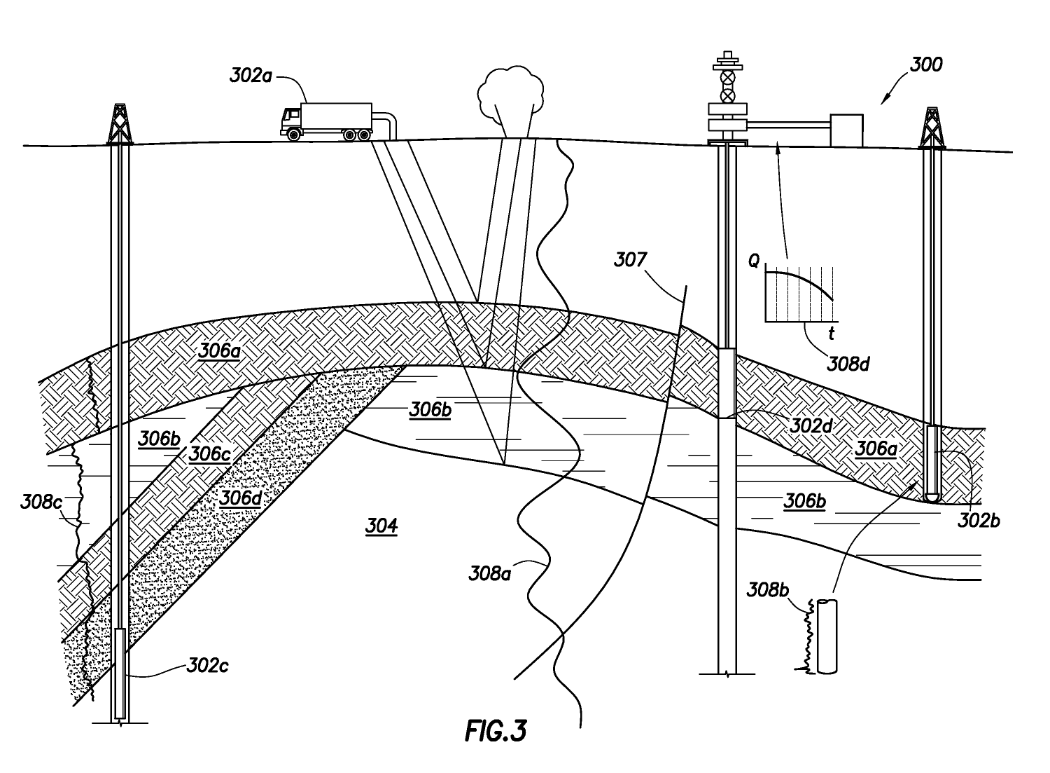

FIGS. 2A-2D are graphical depictions of data collected by the tools of FIGS. 1A-D, respectively. FIG. 2A depicts a seismic trace (202) of the subterranean formation of FIG. 1A taken by survey tool (106a). The seismic trace measures a two-way response over a period of time. FIG. 2B depicts a core sample (133) taken by the drilling tool (106b). The core test typically provides a graph of the density, resistivity, or other physical property of the core sample (133) over the length of the core. Tests for density and viscosity are often performed on the fluids in the core at varying pressures and temperatures. FIG. 2C depicts a well log (204) of the subterranean formation of FIG. 1C taken by the wireline tool (106c). The wireline log typically provides a resistivity measurement of the formation at various depts. FIG. 2D depicts a production decline curve (206) of fluid flowing through the subterranean formation of FIG. 1D taken by the production tool (106d). The production decline curve (206) typically provides the production rate Q as a function of time t.

The respective graphs of FIGS. 2A-2C contain static measurements that describe the physical characteristics of the formation. These measurements may be compared to determine the accuracy of the measurements and/or for checking for errors. In this manner, the plots of each of the respective measurements may be aligned and scaled for comparison and verification of the properties.

FIG. 2D provides a dynamic measurement of the fluid properties through the wellbore. As the fluid flows through the wellbore, measurements are taken of fluid properties, such as flow rates, pressures, composition, etc. As described below, the static and dynamic measurements may be used to generate models of the subterranean formation to determine characteristics thereof.

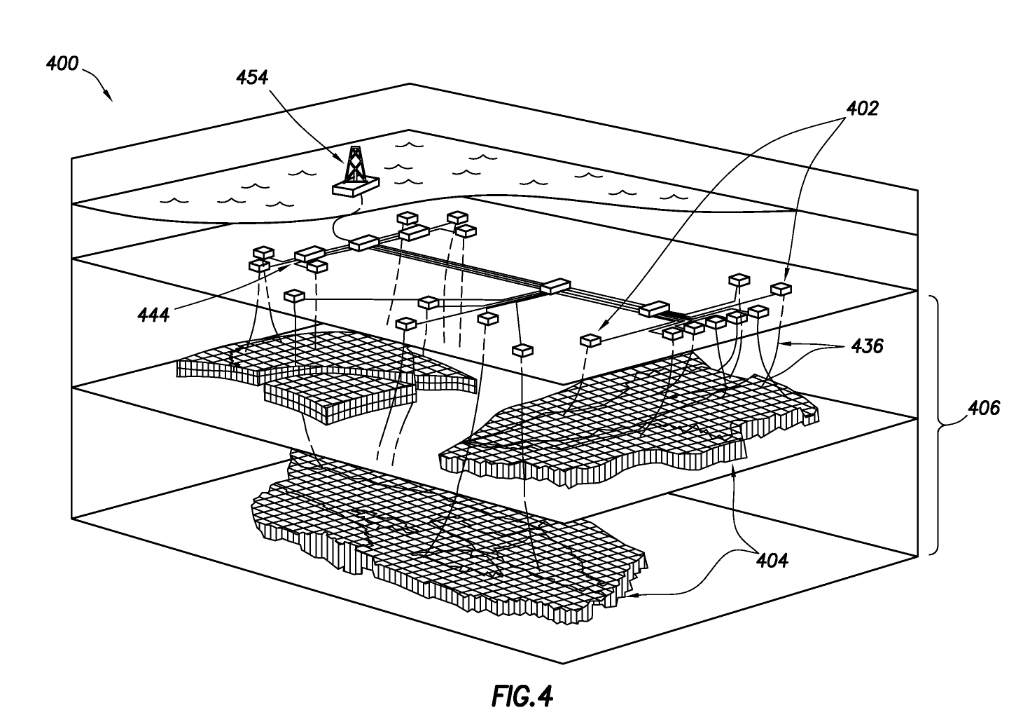

FIG. 3 is a schematic view, partially in cross section of an oilfield (300) having data acquisition tools (302a), (302b), (302c), and (302d) positioned at various locations along the oilfield for collecting data of a subterranean formation (304). The data acquisition tools (302a-302d) may be the same as data acquisition tools (106a-106d) of FIG. 1, respectively. As shown, the data acquisition tools (302a-302d) generate data plots or measurements (308a-308d), respectively.

Data plots (308a-308c) are examples of static data plots that may be generated by the data acquisition tools (302a-302d), respectively. Static data plot (308a) is a seismic two-way response time and may be the same as the seismic trace (202) of FIG. 2A. Static plot (308b) is core sample data measured from a core sample of the formation (304), similar to the core sample (133) of FIG. 2B. Static data plot (308c) is a logging trace, similar to the well log (204) of FIG. 2C. Data plot (308d) is a dynamic data plot of the fluid flow rate over time, similar to the graph (206) of FIG. 2D. Other data may also be collected, such as historical data, user inputs, economic information, other measurement data, and other parameters of interest.

The subterranean formation (304) has a plurality of geological structures (306a-306d). As shown, the formation has a sandstone layer (306a), a limestone layer (306b), a shale layer (306c), and a sand layer (306d). A fault line (307) extends through the formation. The static data acquisition tools are preferably adapted to measure the formation and detect the characteristics of the geological structures of the formation.

While a specific subterranean formation (304) with specific geological structures are depicted, it will be appreciated that the formation may contain a variety of geological structures. Fluid may also be present in various portions of the formation. Each of the measurement devices may be used to measure properties of the formation and/or its underlying structures. While each acquisition tool is shown as being in specific locations along the formation, it will be appreciated that one or more types of measurement may be taken at one or more location across one or more oilfields or other locations for comparison and/or analysis. Further, these measurements do not only elucidate the state of rock and fluids once in time, but also detect and quantify changes in rock and fluids properties with time through carefully designed periodic measurements and surveys.

The data collected from various sources, such as the data acquisition tools of FIG. 3, may then be evaluated. Typically, seismic data displayed in the static data plot (308a) from the data acquisition tool (302a) is used by a geophysicist to determine characteristics of the subterranean formation (304). Core data shown in static plot (308b) and/or log data from the well log (308c) is typically used by a geologist to determine various characteristics of the geological structures of the subterranean formation (304). Production data from the production graph (308d) is typically used by the reservoir engineer to determine fluid flow reservoir characteristics.

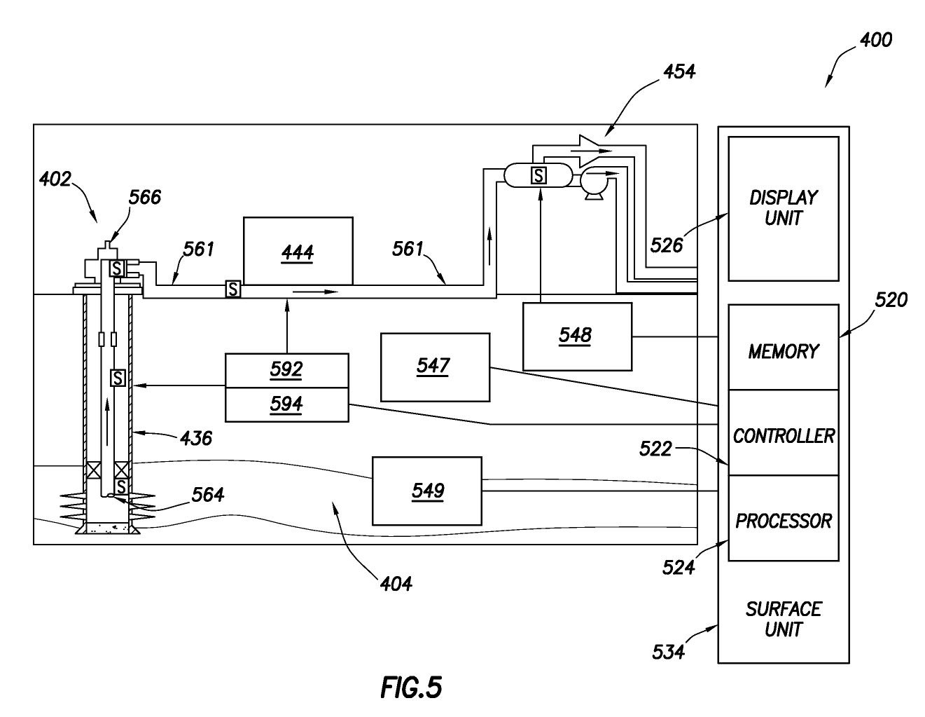

FIG. 4 shows an oilfield (400) for performing simulation operations. As shown, the oilfield has a plurality of wellsites (402) operatively connected to a central processing facility (454). The oilfield configuration of FIG. 4 is not intended to limit the scope of the invention. Part or all of the oilfield may be on land and/or see. Also, while a single oilfield with a single processing facility and a plurality of wellsites is depicted, any combination of one or more oilfields, one or more processing facilities and one or more wellsites may be present.

Each wellsite (402) has equipment that forms a wellbore (436) into the earth. The wellbores extend through subterranean formations (406) including reservoirs (404). These reservoirs (404) contain fluids, such as hydrocarbons. The wellsites draw fluid from the reservoirs and pass them to the processing facilities via gathering networks (444). The gathering networks (444) have tubing and control mechanisms for controlling the flow of fluids from the wellsite to the processing facility (454).

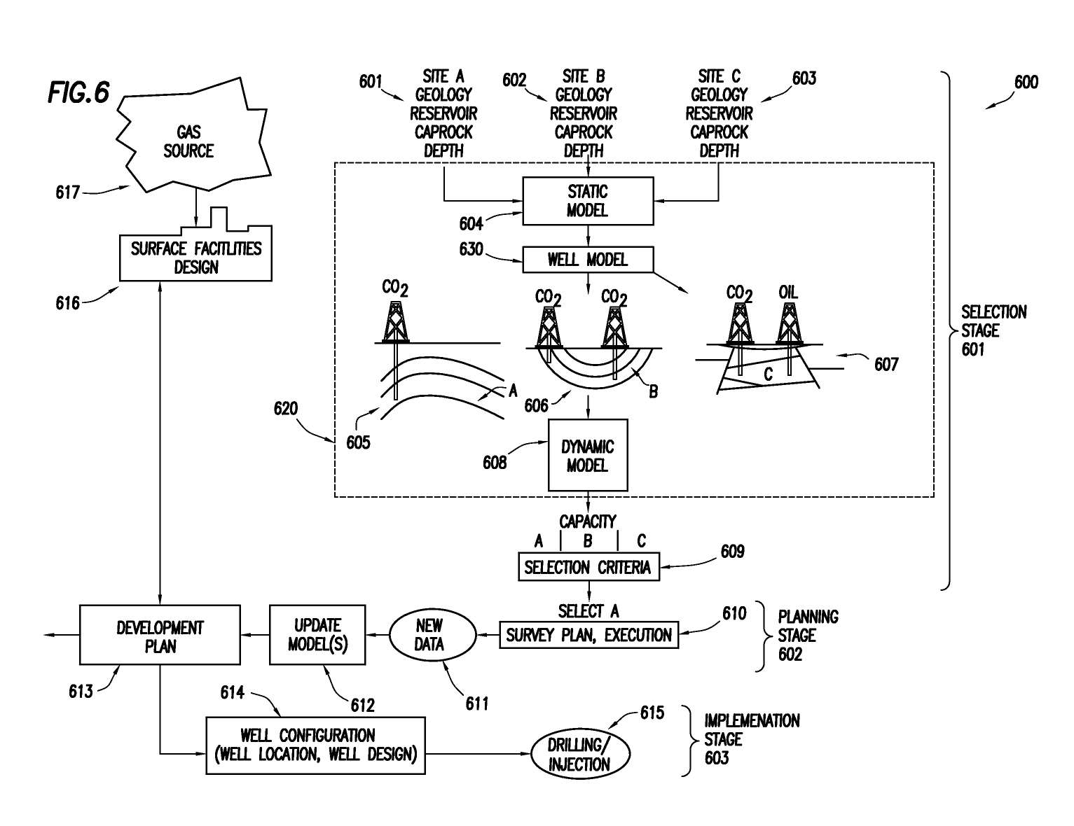

FIG. 5 shows a schematic view of a portion of the oilfield (400) of FIG. 4, depicting a wellsite (402) and gathering network (444) in detail. The wellsite (402) of FIG. 5 has a wellbore (436) extending into the earth therebelow. As shown, the wellbore (436) has already been drilled, completed, and prepared for simulation from reservoir (504).

Wellbore simulation equipment (564) extends from a wellhead (566) of wellsite (402) and to the reservoir (404) to draw fluid to the surface. The wellsite (402) is operatively connected to the gathering network (444) via a transport line (561). Fluid flows from the reservoir (404), through the wellbore (436), and onto the gathering network (444). The fluid then flows from the gathering network (444) to the process facilities (454).

As further shown in FIG. 5, sensors (S) are located about the oilfield (400) to monitor various parameters during oilfield operations. The sensors (S) may measure, for example, pressure, temperature, flow rate, composition, and other parameters of the reservoir, wellbore, gathering network, process facilities and/or other portions of the oilfield operation. These sensors (S) are operatively connected to a surface unit (534) for collecting data therefrom. The surface unit may be, for example, similar to the surface unit 134 of FIGS. 1A-D

As shown in FIG. 5, the surface unit (534) has computer facilities, such as memory (520), controller (522), processor (524), and display unit (526), for managing the data. The data is collected in memory (520), and processed by the processor (524) for analysis. Data may be collected from the oilfield sensors (S) and/or by other sources. For example, oilfield data may be supplemented by historical data collected from other operations, or user inputs.

The analyzed data may then be used to make decisions. A transceiver (not shown) may be provided to allow communications between the surface unit (534) and the oilfield (400). The controller (522) may be used to actuate mechanisms at the oilfield (400) via the transceiver and based on these decisions. In this manner, the oilfield (400) may be selectively adjusted based on the data collected. These adjustments may be made automatically based on computer protocol and/or manually by an operator. In some cases, well plans are adjusted to select optimum operating conditions or to avoid problems.

A display unit (526) may be provided at the wellsite (402) and/or remote locations for viewing oilfield data (not shown). The oilfield data represented by a display unit (526) may be raw data, processed data and/or data outputs generated from various data. The display unit (526) is preferably adapted to provide flexible views of the data, so that the screens depicted may be customized as desired. A user may determine the desired course of action during simulation based on reviewing the displayed oilfield data. The simulation operation may be selectively adjusted in response to the display unit (526). The display unit (526) may include a two dimensional display for viewing oilfield data or defining oilfield events. For example, the two dimensional display may correspond to an output from a printer, plot, a monitor, or another device configured to render two dimensional output. The display unit (526) may also include a three-dimensional display for viewing various aspects of the simulation operation. At least some aspect of the simulation operation is preferably viewed in real time in the three-dimensional display. For example, the three dimensional display may correspond to an output from a printer, plot, a monitor, or another device configured to render three dimensional output.

To facilitate the processing and analysis of data, simulators may be used to process the data. Specific simulators are often used in connection with specific oilfield operations, such as reservoir or wellbore simulation. Data fed into the simulator(s) may be historical data, real time data or combinations thereof. Simulation through one or more of the simulators may be repeated or adjusted based on the data received.

As shown, the oilfield operation is provided with wellsite and non-wellsite simulators. The wellsite simulators may include a reservoir simulator (549), a wellbore simulator (592), and a surface network simulator (594). The reservoir simulator (549) solves for hydrocarbon flow through the reservoir rock and into the wellbores. The wellbore simulator (592) and surface network simulator (594) solves for hydrocarbon flow through the wellbore and the surface gathering network (444) of pipelines. As shown, some of the simulators may be separate or combined, depending on the available systems.

The non-wellsite simulators may include process and economics simulators. The processing unit has a process simulator (548). The process simulator (548) models the processing plant (e.g., the process facility (454)) where the hydrocarbon is separated into its constituent components (e.g., methane, ethane, propane, etc.) and prepared for sales. The oilfield (400) is provided with an economics simulator (547). The economics simulator (547) models the costs of part or all of the oilfield throughout a portion or the entire duration of the gas operation. Various combinations of these and other oilfield simulators may be provided.

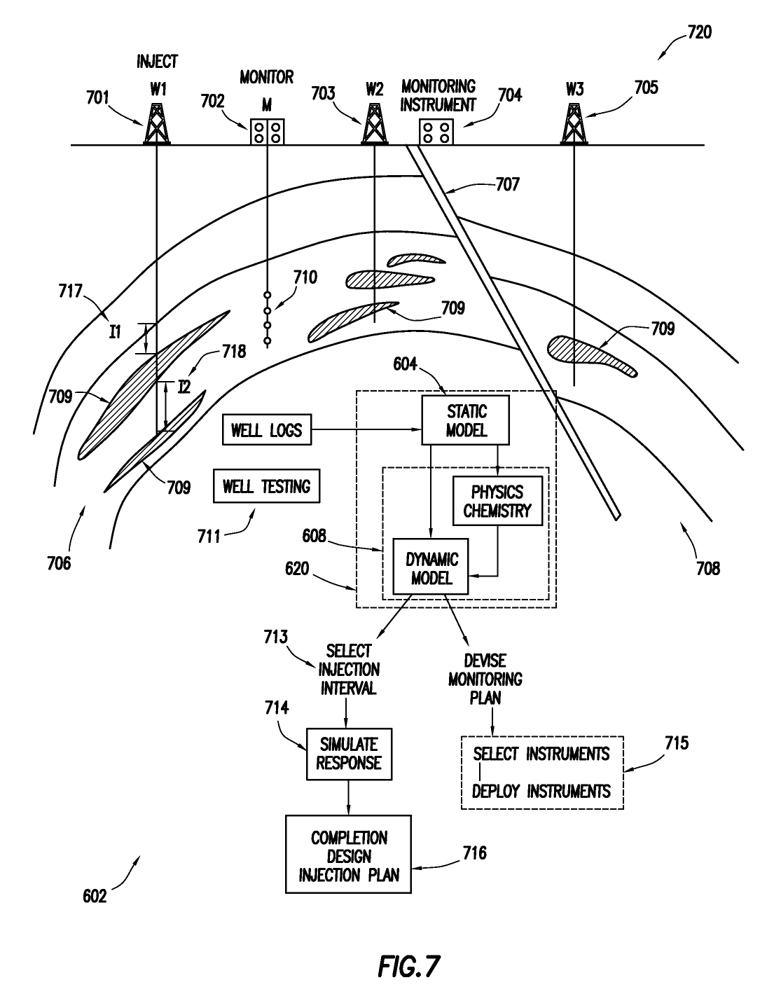

FIGS. 6-9 show schematic diagrams of a various aspects of a gas operation (600) for an oilfield. The gas operation (600) is performed in various stages, such as the site selection, characterization, planning, implementation, risk assessment, and shut down/retirement stages.

FIG. 6 depicts a gas operation (600) for an oilfield, such as the oilfield of FIGS. 4-5. The gas operation (600) involves the selection of a site, such as a portion of the oilfield of FIGS. 4-5, for disposal (e.g., permanent disposal or temporary storage with subsequent production, etc.) of gas. The gas operation of FIG. 6 shows the site selection stage (601), the planning stage (602) and implementation stage (603).

The site selection stage (601) involves a review of potential sites A, B, and C of an oilfield that may be used for disposal of gas. In one or more embodiments of the invention, the oilfield may be any geographical region having geological structures (e.g., saline aquifers, brine reservoirs, hydrocarbon reservoirs, other fluid bodies or cavities, etc.) capable of receiving and storing the gas. During site selection, data is collected and processed for each of the sites, an initial risk identification, and assessment survey is made. Then, each site is modeled to determine its viability as a disposal site. A multi-domain simulator (620) is used to model site A, site B, and site C for ranking and selective targeting gas disposal site, e.g., site A.

Once the site is selected, the planning stage is performed (602). During the planning stage, a survey plan (610) is developed to acquire survey data (611) for updating the modeling and defining the development plan (613) to generate the well configuration (614) and the surface facility design (616).

Once the site is planned, the implementation stage is performed (603). During the implementation stage, the drilling operation and/or injection operation (615) are performed based on the well configuration (614). Surface facilities are designed and built. The gas produced from the gas source (617) is disposed on the surface facilities (616).

As shown in FIG. 6, the gas operation is performed to provide for disposal of various gases, such as carbon dioxide (CO₂). As provided herein, CO₂ may be depicted as the gas used in various examples. However, any gas (including existing contaminants) may be provided from a variety of sources. For example, gas from a gas source (617) may be produced from a gas field, a coal burning power plant, or other gas sources. The gas may be produced over a long period of time, e.g., over decades, and may be characterized by various parameters such as the gas composition, the flow rate, the total amount, etc. Once collected, the gas may be disposed in the site selected by the techniques depicted herein. In one or more embodiments of the invention, gas may be in any state attained as a result of changes in pressure, temperature, and/or composition. For example, in addition to dispose gas in gaseous phase, the gas operation may also dispose gas that has transformed into liquid or hydrates.

In the example depicted, three sites (i.e., site A, site B, and site C) are considered for disposing the carbon dioxide produced from the gas source (617). The sites are evaluated to determine their ability to store the CO₂. Various considerations, such as the static, dynamic, and wellbore characteristics as well as likelihood of associated identified risks may be considered in site selection.

The multi-domain simulator (620) is used to evaluate the static, dynamic, and wellbore characteristics. As shown, a static model (604) is used to evaluate the static or geological characteristics of each of the sites. The geological structure of a given site may include the various underground formations, such as rock layers, faults, coal beds, associated cap rock formations and other structures, contained in the site. In many cases, the formation may include mostly sedimentary deposits having porosity suitable for gas storage.

A well model (630) is also used to evaluate the wellbore characteristics of the sites. The wellbore characteristics relate to the shape, direction and other features (e.g. completion) of the wellbore that may affect the flow of fluid therethrough. Such features may affect, for example, the ability to transport gas to a particular location.

A dynamic model (608) is also used to evaluate the reservoir or dynamic characteristics of reservoirs within the various sites including geological formations overlaying the reservoir (e.g., cap rock or overburden). The sites have saline aquifers, brine reservoirs, hydrocarbon reservoirs, and other fluid bodies or cavities capable of receiving and storing the gas. Such features, such as capacity, may affect the ability of a reservoir to store the gas.

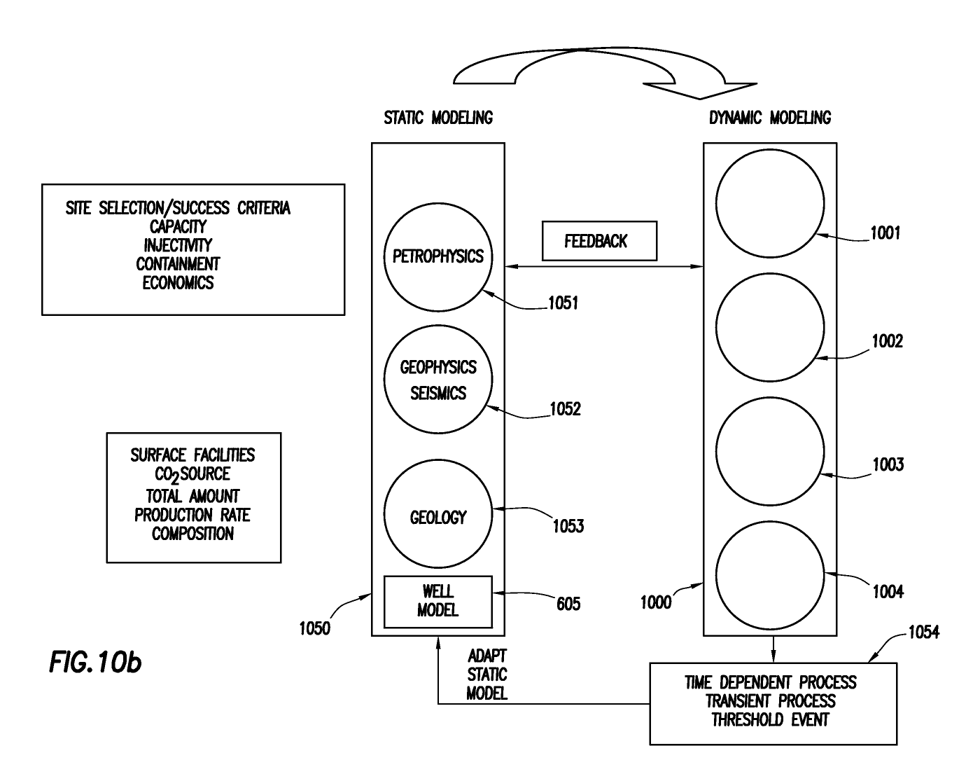

Preferably, the models used to perform the site selection are coupled to provide the overall best solution based on all the models. The operation of the various model and the coupling of these models are described in further detail with respect to FIGS. 10A-10B.

In the example shown in FIG. 6, site A is an anticline aquifer (605) with a carbon dioxide injection well, site B is a syncline aquifer (606) with two carbon dioxide injection wells, and site C is an oil field with a combination of carbon oxide injection well and oil well. Site A and site B may be suitable for injecting carbon dioxide into the aquifers for storage purpose while carbon dioxide injection may additionally enhance the oil retrieval efficiency in site C. Based on a pre-determined criteria (609), a site, e.g., site A, may be selected as the target site for the gas operation. The pre-determined criteria depends on the characteristics of the gas source (617) and relates to the performance of the gas operation (600) such as capacity, injectivity, containment, economics, and other suitable performance categories. Each site may be modeled to estimate the performance in each of these categories.

Analysis based on the performance categories overlays the entire gas operation and may be performed at any point in the operation or for the entire operation.

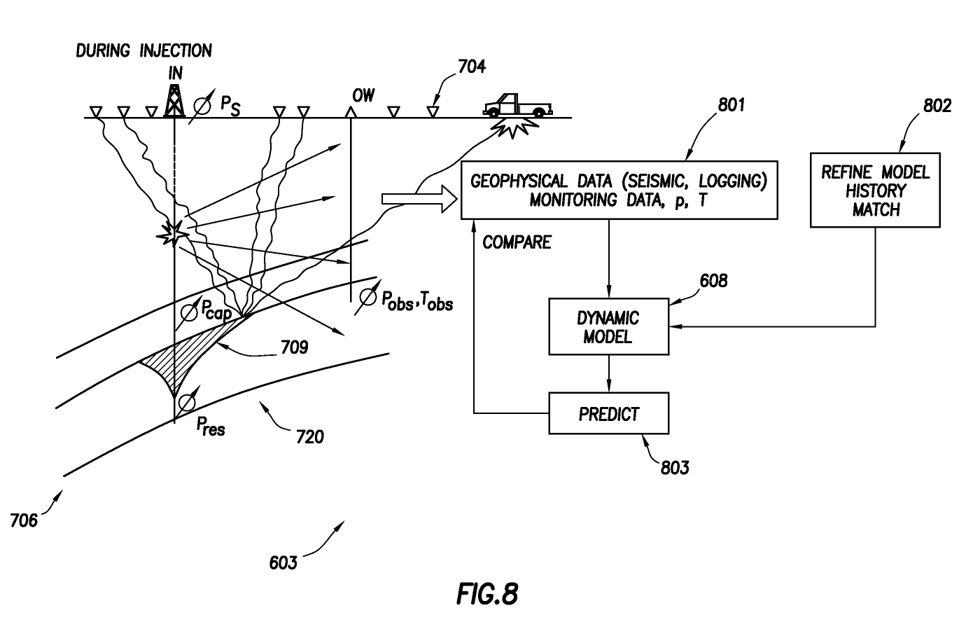

Once the site selection stage is complete, the planning stage (602) may begin. With the target disposal site selected, survey data (611) is acquired from the selected site to update one or more of the models (612). A development plan (613) is then defined based on modeling the gas operation using the multi-domain simulator (620) with the updated model(s), such as the static model (612), well model (630) and/or dynamic model (608). The development plan (613) may provide well location, well design, drilling plan, gas injection plan, monitoring plan, etc. The planning stage is described in greater detail below with respect to FIG. 7.

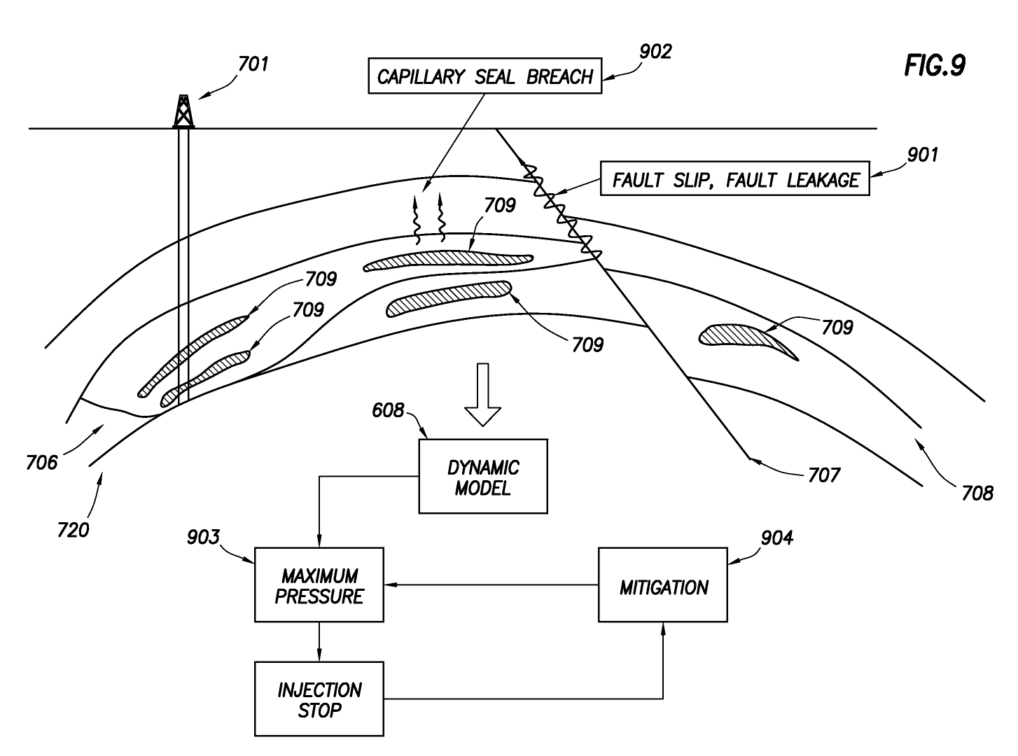

Once the planning stage is complete and a plan is defined, the implementation stage (603) may begin. The implementation stage (603) takes action based on the development plan (613) provided. The development plan (613) defines the operating parameters (614), such as well location and well design. The development plan also defines the drilling and/or injection operation (615), such as the equipment and drilling parameters for drilling the well to the desired site. The implementation stage (603) is described in greater detail with respect to FIG. 8.

FIG. 7 shows the planning stage (602) for a selected site in detail. Here, the multi-domain simulator (620), which is shown in both FIG. 6 above and FIG. 7, is used to model the gas operation (600) of the selected site to further validate the field development plan.

As an example, site A, as shown in FIG. 6, is targeted as the gas disposal site (720) shown in FIG. 7. Injection wells (701), (703), (705), monitoring well (702), and monitoring instruments (704), (710) are deployed (e.g., based on the development plan modeling using the multi-domain simulator (620) as shown in FIG. 6 above) to inject gas into aquifers (709) located about the subterranean formations (706), (708), and fault (707). Prior to performing the gas injection operation, monitoring data (711) (e.g., well logs, well testing, etc.) obtained from the gas disposal site (720) is provided to the multi-domain simulator (620) to model the injection operation. An injection plan (716) and a monitoring plan (715) are defined based on the modeling.

The multi-domain simulator (620) includes the static model (604) and the dynamic model (608). The monitoring data (711) (e.g., well logs, well testing, etc.) is provided to update the static model (604) and the dynamic model (608), which is based on the previous knowledge and survey data of subsurface geological make up in modeling the site selection stage and pre-drilling stage as illustrated in FIG. 6 above. As shown in FIG. 7, modeling of the gas disposal site (720) may be performed using the multi-domain simulator (620) as described in detail with respect to FIGS. 10A and 10B.

Key parameters (713) of the injection operation (e.g., the injection interval, injection cycle, injection rate, etc.) are simulated to evaluate the response (714) before the injection plan (716) is finalized. Monitoring plan (715) is devised for acquiring monitoring data (711) from the monitoring instrument (704) and monitoring instrument (710).

Regarding the injection plan (716), injection scenarios can be simulated in selected sections (e.g., I₁ (717), I₂ (718), etc.) to select the best injection interval and injection strategy (e.g., continuous injection, interval injection, water-alternating (WAG) injection, etc.). The result supports operational decisions such as using a single well for injection or setting up a multi-well operation (e.g. including injection well W₁ (701) and injection well W₃ (705), but excluding injection well W₂ (703)). Also, at the pre-injection stage, with the properties of the subsurface fluids (e.g., brine) known, eventual problems or benefits (e.g., caused by dry-out, salting out, induced chemical reactions, etc.) can be evaluated and mitigation strategies tested. Similar simulations can also aid the design and placement of monitoring equipment in the monitoring well (702).

Regarding the monitoring plan (715), the prediction of the behavior of the CO₂ (e.g., displacement of the plume, trapping mechanisms, etc.) allows an optimum monitoring strategy to be defined for controlling the performance of the gas disposal site with respect to the storage objective. For example, measurement techniques and appropriate sensors may be selected for being sensitive to a certain gas presence or changes in reservoir properties (e.g., pressure) due to gas injection. This selection is performed using tool response models (not shown) representing the instruments and sensors (e.g., monitoring instrument (704) and/or monitoring instrument 710) coupled with the simulators (e.g., static model (604) and the dynamic model (608)) in the multi-domain simulator (620). Further, the monitoring plan (715) also includes planning monitoring wells (e.g., monitoring well (702)), such as designing surface survey, surface-to-borehole survey, or borehole measurement surveys. These surveys can be included in the multi-domain simulator (620) to evaluate the efficacy to finalize the monitoring plan (715).

FIG. 8 depicts the implementation stage (603) of the gas operation in greater detail. FIG. 8 shows injection of the gas into the selected site. Here, the multi-domain simulator, which is also shown in FIGS. 6 and 7 above, is used to model the injection operation of the gas disposal site (720).

The gas disposal site (720) includes the aquifer (709) located about the subterranean formation (706) and monitoring instruments (704) shown in FIG. 7 above. Once injection has commenced and monitoring data stream (801) established, these measurements are used to calibrate and/or refine (802) the reservoir model (e.g., static model (604), well model (630), dynamic model (608), etc. shown in FIG. 6 above) by comparison between the actual measurements from the monitoring data stream (801) and the results (803) predicted by simulation using the multi-domain simulator.

For example, outputs from the dynamic model (608), such as pressure and saturation distributions, are inputs for tool response modeling (i.e., resistivity, seismic, gravity survey, etc.). Noticeable discrepancies between predicted and actual tool measurements allow updating model parameters, such as properties or geometry.

The mismatch between observation data and predictions is generally due to an oversimplified reservoir model. In that case, the model is refined and parameters are added until predictions agree with observations. Repeated history matching exercises allow models to be updated and further refined. This workflow loop can be repeated during the whole injection operation lifetime. Recorded changes in behavior can be simulated to better understand the parameters responsible for deviations and the consequences of adjustments of operation parameters, such as well shut-in, changes in injection rates, work-overs, etc.

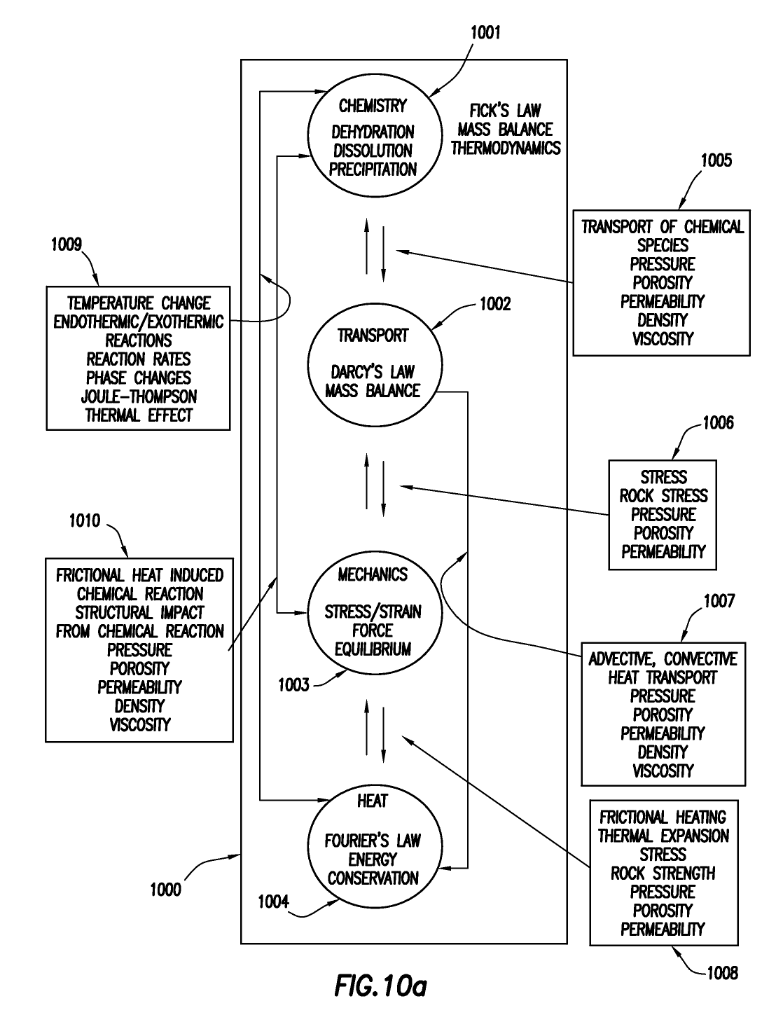

FIG. 9 shows an exemplary schematic diagram of a risk assessment stage of the gas operation. The risk assessment stage may be performed at any time during the gas operation to determine various risks associated with the oilfield operation. As shown in FIG. 9, the gas disposal site (720) is modeled with risk assessment. Here, the gas disposal site (720) is essentially the same as shown in FIG. 7 above with the exception of the added component such as a fault slip or fault leakage (901) causing a capillary seal breach (902). This added component is an example for concern to the gas operation that necessitates risk assessment.

Further as shown in FIG. 9, various scenarios associated with the fault slip or fault leakage (901) may be modeled as the risk assessment scenario (903) (e.g., maximum pressure scenario) using the dynamic model (608) of the gas disposal site (720). The gas disposal site (720) includes the injection well (701), the aquifers (709) located about the subterranean formations (706), (708), and fault (707), as well as a fault slip or fault leakage (901) causing a capillary seal breach (902).

As knowledge in the reservoir is increased (e.g., based on the repeated history matching exercises described above), additional risk assessment scenarios (903) (e.g., gas escape and leakage scenario, etc.) may be modeled for the purpose of understanding and assessing risk of the gas injection operation. This also supports devising remediation strategies (904) (e.g., mitigation) and testing its potential effectiveness in models before implementation.

During the operation (cessation of injection, also referred to in FIG. 9 as injection stop), it may be desirable to have an appropriate abandonment strategy. The information flow from monitoring and the history matching adjustments provides the best possible site model. This is used to look into the future flow of fluids (e.g., CO₂ and re-adjustments of original reservoir fluids), pressure equilibration, formation, or free CO₂ gas cap. Long-term monitoring of the retired field is planned by using the forward models to assess effectiveness.

Even after abandonment, longer term monitoring continues and the data is incorporated into models that can be updated should changes in the subsurface conditions be detected. Also in case of larger deviations caused by unexpected and unplanned events (e.g., leakage, early attainment of max pressure, etc.), models can be used to plan and assess mitigation actions.

In addition to the site selection, characterization, planning, implementation, and risk assessment stages of the gas operation (600), shut down/retirement stage involves shutting down operations, for example, for preparing the field for retirement or extracting the gas at a later time for use elsewhere. Retirement strategy and abandonment plan/actions on facilities are designed using modeling techniques described above. For instance, if after several years of shut-in phase (injection stop), the monitoring system still records significant changes in reservoir parameters, these data may be used to decide on an extension of the shut-in phase. The retirement strategy may include treating the reservoir chemically by injecting specific engineered fluids to isolate the near wellbore area over the very long term. Simulations will indicate how to best perform these operations for obtaining the desired result.

FIGS. 10A and 10B depict various aspects of the multi-domain simulator (620) in greater detail. A dynamic model (608) of the multi-domain simulator (620) is shown in greater detail in FIG. 10A. The multi-domain simulator (620) is shown in greater detail in FIG. 10B. The multi-domain (620) simulator has a dynamic model (608), well model (630) and a static model (604). The dynamic model (608) and static model (604) may be, as shown in this example, the same as models (604) and (608) respectively of FIG. 6.

FIG. 10A show an exemplary schematic diagram of a dynamic model (608) and a static model (604) in the multi-domain simulator (i.e., the multi simulator (620) shown in FIG. 6-9 above). The dynamic model (608) and the static model (604) may include computer models addressing multiple disciplines or aspects of the gas operation, such as the chemistry aspect (1001) in FIG. 10a, the transport aspect (1002) in FIG. 10A, the mechanics aspect (1003) in FIG. 10a, the heat aspect (1004) in FIG. 10A, the petrophysics aspect (1051) in FIG. 10b, the geophysics/seismic aspect (1052) in FIG. 10B, and the geology aspect (1053) in FIG. 10B. A well model (630) (as shown in FIG. 6 above) is included as an example of the static model (604). Models for each of these aspects are linked by multi-domain coupling modules (1005)-(1010) in FIG. 10A and (1054) in FIG. 10B. Additional multi-domain coupling modules may exist within the static model (604), but are not shown for simplicity sake.

Multiple disciplines, or aspects, are addressed in modeling the gas operation within the multi-domain simulator (620). These disciplines include TRANSPORT (e.g., of fluids, chemicals, heat, etc.), HEAT (e.g., temperature changes, energy sources and sinks, etc.), MECHANICS (e.g., pressure impact, fracturing, etc.), CHEMISTRY (e.g., thermodynamics, chemical reactions affecting material properties, etc.), etc. Key parameters and dependencies in these disciplines are coupled in complex ways, e.g., the density of materials (such as rocks, fluids, well completion materials, etc.) changes with variations of temperature (HEAT), pressure (MECHANICS), chemical reactions (CHEMISTRY), transport and mixing with other materials (TRANSPORT). Performance of the gas operation in capacity, injectivity, containment, economics, or other categories are modeled by coupling mathematical equations representing each discipline in an integrated system. Subsystems (i.e., portions or limited aspects of the gas operation) are modeled by portions of these mathematical equations. These mathematical equations represent coupled processes in these disciplines that are simulated accurately for selected subsystems and integrated for full system analysis. For example, the relevant processes modeled in these categories are described in the following paragraphs.

Storage capacity and trapping mechanisms are modeled in the capacity category. For example, trapping mechanism kinetics, such as structural/hydrodynamics, solubility, residual phase, mineralization/absorption, etc., are modeled. Further, storage properties evolution, such as CO₂ saturation, dissolved CO₂, pressure, pH, etc., are modeled for model parameter calibration using monitoring measurements.

Injectivity relates to injection optimization near a wellbore in the gas disposal site. Injection-induced temperature variations, pressure increase, and chemical reactions (e.g., salt precipitation, CaCO₃ dissolution/precipitation) and their effects on porosity, permeability, and mechanical properties (e.g., stresses to control subsidence in case of carbonate dissolution and to control completion integrity) are modeled in this category. Near wellbore properties (e.g., temperature profile, pressure, CO₂ saturation, pH and other properties) are modeled for comparison with monitoring measurements and further calibration of the simulator parameters. Injection cycles are modeled in injecting CO₂ alternated with another substance to maintain well injectivity. Further, the network of injection wells (e.g., number, trajectory, etc.) is modeled and optimized to ensure long-term stability of injection capabilities at the lowest cost and to minimize the risks of leakage. Effect of impurities in the gas stream may also be modeled. For all the above aspects of the injectivity modeling, the local grid may be refined manually or automatically for detailed analysis of near wellbore conditions.

In the containment category, the effects of pressure increase on storage seal integrity (e.g., caused by fault-reactivation, cap rock fracturing, and/or over pressuring the reservoir) are modeled. Reactive transport in cap rock formation and in fault gouge/cement materials (primary seal) is also modeled. CO₂ seepage in the overburden (including vadose zone) and trapping mechanisms along these leakage routes is modeled to assess impact and to devise mitigation for shallow fresh water resources. Modeling in the containment category is coupled to responses of environmental surface monitoring.

Using simplified geological models based on previous knowledge of subsurface geological make up (e.g., of site A, site B, and site C) simulation of CO₂ injection provides pre-selection capacity estimation, which is one of the ranking criteria for site selection. Further, a development plan for the gas operation is modeled. As described above, the development plan includes well location, well design, drilling plan, gas injection plan, monitoring plan, etc. The modeled injection strategy (e.g., number of wells, type of wells, injection rates, etc.) and surface considerations (e.g., distance from CO₂ source, transport mode, accessibility to facilities and storage site) allow first order assessment of economics.

In modeling the chemistry aspect (1001) in FIG. 10a, various mechanisms may be addressed, such as thermodynamics, mass balance, dehydration, dissolution, precipitation, Fick's Law, etc. In modeling the transport aspect (1002) in FIG. 10a, various mechanisms may be addressed, such as mass balance, Darcy's Law, etc. In modeling the mechanics aspect (1003) in FIG. 10a, various mechanisms may be addressed, such as stress, strain, force equilibrium, etc. In modeling the heat aspect (1004) in FIG. 10a, various mechanisms may be addressed, such as the energy conservation, Fourier's Law, etc. The petrophysics aspect (1051) in FIG. 10b may address monitoring data acquired from a well, the geophysics/seismic aspect (1052) in FIG. 10b may address seismic survey data of subsurface formations, and the geology aspect (1053) in FIG. 10b may address geological data obtained from core sample analysis or other geological surveys.

The various stages of the gas operation described in FIG. 6-9 above include complex processes that involve interacting mechanisms between these various aspects (1001)-(1004) in FIG. 10a, (1051)-(1053) in FIG. 10b. As an example, the porosity of the reservoir rock may change due to thermal expansion (HEAT), mechanical compression (MECHANICS), dissolution or precipitation (CHEMISTRY). Such changes affect fluid (liquid and gas) flow through the reservoir (TRANSPORT). The complex processes demand a large number of parameters and data obtained from many different measurement systems and a large set of general equations to be solved. The multi-domain coupling modules (1005)-(1010) in FIG. 10a and (1054) in FIG. 10b simplify this computing intensive task by converting this large set of general equations into problem specific simulation modules so that the simulation run time is practical for simulating the various stages of the gas operation described in FIG. 6-9 above. Selected mathematical formulations of the dependencies of parameters (e.g. porosity) of each aspect (heat, mechanics, chemistry, etc.) in the simulator allow, for example, the influence of these parameters on fluid flow (i.e., transport aspect) to be evaluated and the behavior of the rock and fluids with respect to each aspect to be coupled and properly simulated.

Turning to FIG. 10A, the multi-domain coupling module (1005) simplifies the interacting mechanisms between the chemistry aspect (1001) and the transport aspect (1002) to address transport of chemical species, pressure, porosity, permeability, density, viscosity, etc.

The multi-domain coupling module (1006) simplifies the interacting mechanisms between the transport aspect (1002) and the mechanics aspect (1003) to address stress, rock strength, pressure, porosity, permeability, etc.

The multi-domain coupling module (1007) simplifies the interacting mechanisms between the transport aspect (1002) and the heat aspect (1004) to address advective or convective heat transport, pressure, porosity, permeability, density, viscosity, etc.

The multi-domain coupling module (1008) simplifies the interacting mechanisms between the mechanics aspect (1003) and the heat aspect (1004) to address frictional heating, thermal expansion, stress, rock strength, pressure, porosity, permeability, etc.

The multi-domain coupling module (1009) simplifies the interacting mechanisms between the chemistry aspect (1001) and the heat aspect (1004) to address temperature change, endothermic/exothermic reactions, reaction rates, phase changes, Joule-Thompson thermal effect, etc.

The multi-domain coupling module (1010) simplifies the interacting mechanisms between the mechanics aspect (1003) and the chemistry aspect (1001) to address frictional heat induced chemical reaction, structural impact from chemical reaction, pressure, porosity, permeability, density, viscosity, etc.

Now turning to FIG. 10B, the multi-domain coupling module (1054) simplifies the interacting mechanisms between the dynamic model (608) and the static model (1054) to address time dependent process, transient process, threshold event, etc.

Each multi-domain coupling module is customized for a specific problem to achieve computational efficiency. Specific problems may include certain physical and chemical processes in the subsurface induced by the presence of CO₂ (and associated gases) either through deliberate injection for sequestration and/or enhanced oil recovery (EOR) or due to natural occurrence. Examples include thermodynamic equilibration of the various phases, model for capillary pressure and relative permeability hysteresis, models for the dissolution and precipitation of salts and minerals, chemical reactions of these components and adsorption/desorption mechanisms for gases (e.g. CH₄/CO₂) as well as shrinkage/swelling of coals, mechanical compression of rock matrix, etc.

As an example, the multi-domain coupling module (1005) and (1054) is customized for the specific problem relating to CO₂ injection into a brine reservoir described below. During dry CO₂ injection in saline aquifers, the near wellbore environment is driven to residual water saturation. Over a period of time, governed by the mass transfer of water into the CO₂ rich phase, the formation water is evaporated causing dissolved salt to precipitate in the pore spaces. This reduces the porosity and decreases the permeability of the formation to CO₂. This coupling between chemistry aspect (1001) (i.e., mutual solubility between water and CO₂) and transport aspect (1002) (i.e., the decrease in the permeability of the formation to CO₂) is modeled by the multi-domain coupling module (1005) in the following manner. The near wellbore environment is modeled as a multi-phase system of CO₂ and H₂O partitioned in a CO₂-rich and H₂O-rich phase, including, for example, the four components:

CO₂—liquid/vapour component

H₂O—liquid/vapour component

NaCl—liquid/solid component

CaCl₂—liquid/solid component

The salt concentrations are assumed to vary slowly so the partial derivatives of the phase splitting with respect to the salt concentrations are set to zero in the Jacobian used for iterative updating. This reduces the computational overhead.

An exemplary algorithm for phase compositional computations is described below. Given the molar density mᵢ of each component, the pressure P, and the temperature T, the compositions are calculated in the following steps.
Step 1. Separate pure solid components from the modeling and assign initial estimate to L, V, S, sᵢ, xᵢ and yᵢ.
Step 2. Calculate the total mole fraction zᵢ (all phases put together)
Step 3. Given zi, P, T carry out phase splitting calculations: Obtain the solid mole fraction S, the liquid mole fraction L and the vapour mole fraction V. Also obtain the phase component mole fractions si—solid, xi—liquid and yi—vapour):

Do until change in S, L, V, xᵢ, yᵢ and sᵢ<Tolerance (a predetermined number)
Calc solubilities X_{CO2} and Y_{H2O} as function of P,T and salt molalities.

Set X_{H2O}=1.0−X_{CO2}−xₛₐₗₜ

K_{CO2}=Y_{CO2}/X_{CO2}

K_{H2O}=Y_{H2O}/X_{H2O}

K_{NaCl}=1E−12 (small number)

K_{CACL2}=1E−12

Set vapour-liquid feed z^{VL}ᵢ=(zᵢ−S*sᵢ)/(1−S)
Solve the mole balance equation from the equilibrium Kᵢ=yᵢ/xᵢ values and z^{VL}ᵢ

$$G ( {V}_{2} , K ) = {\sum }_{i} {y}_{i} - {\sum }_{i} {x}_{i} = {\sum }_{i} \frac{{K}_{i} {z}_{i}^{VL}}{1 + ( {K}_{i} - 1 ) {V}_{2}} - \sum ( \frac{( {K}_{i} - 1 ) {z}_{i}^{VL}}{1 + ( {K}_{i} - 1 ) {V}_{2}} = 0 \\ Set V = {V}_{2} * ( 1 - S ) \\ Set L = ( 1 - {V}_{2} ) * ( 1 - S )$$

Take away vapour moles from feed
Calculate the maximum salt/solid solubility in water by
   Thermodynamic methods known in the art
   Simplified explicit expressions that are built by matching experimental data.
Split the moles between liquid and solid and update L, S, xi and si
Update xₛₐₗₜ=x_{NaCl}+X_{CaCl2}
Update molalities of salt in water

### Enddo

The solid saturation can be transformed into volume of salt precipitated indicating the associated reduction in porosity. The impact of the porosity change on permeability (and flow) is described with a mobility impact factor that may be calibrated on laboratory data by the user.

When CO₂ is injected, the salt concentration in water increases because water is evaporated from the brine into the CO₂ phase. Another case is when pressure and temperature change cause a modification of the solubility of various salts resulting in existing salts being dissolved or precipitated. This can ultimately lead to precipitation of salt when the concentration of NaCl exceeds a salination limit, i.e., the maximum NaCl solubility. This limit depends on the presence of other salts, e.g., CaCl₂. Thermodynamic calculations within a compositional simulator are carried out for each grid block. These calculations are computational resource intensive and may multiply the computational time by a large factor. In an example, the multi-domain coupling module (1001) is customized to use explicit expressions to circumvent the large scale iterative calculation. These explicit expressions are customized for modeling the NaCl precipitation. Different salts (other than NaCl) or different equilibria (other than precipitation) require different explicit expressions. The maximum NaCl solubility in water is pre-calculated separately using a chemical speciation software. The results are fit to a curve fitting function (e.g., Pade approximation) that takes both temperature and CaCl₂ into account. An explicit relationship for NaCl precipitation in the formation as a function of mole fraction of CaCl₂ and temperature is obtained.

The thermodynamic calculations are simplified.

The conservation of total NaCl in a grid cell i is then given by the equation

$$\frac{\partial }{\partial t} {V}_{p} {m}_{NaCl} + {\sum }_{j} {F}_{i \to j} + {Q}_{w} = 0$$

where V_{P} is the pore volume, F_{i->j} denotes the flow of water NaCl in/out from cell i to cell j and Q_{w} is a source sink term representing wells.

Additional to the precipitation problem in the near wellbore environment, modeled using the customized multi-domain coupling module (1005) described above, the impact of dissolution and precipitation in the rock may change the pore space geometry in the rock and can change fundamentally the space available for fluids to move and impact pressures in the reservoir and the wells. The mapping of porosity changes into permeability changes is another example of a specific problem to be modeled by customizing the multi-domain coupling module (1001). The results can lead to the necessity of adjustments of the surface facilities to ensure continuation of the gas operation.

Furthermore, time dependent processes and transient processes exhibited in the CO₂ injection into a brine reservoir are modeled by customizing the multi-domain coupling module (1054) in a similar fashion based on the above description.

As another example, the multi-domain coupling module (1005) for modeling CO₂ injection (or gas mixtures) into a coal bed is customized for the specific problem described below. One of the geological storage options is to inject CO₂ into coal beds containing methane. Methane is preferentially released and CO₂ adsorbed. The multi-domain coupling module (1005) is customized for modeling coal shrinkage/swelling effects when injecting CO₂ into coal seams.

A rock compaction model based on the Palmer and Mansoori model has the weakness of predicting volumetric strain due to swelling/shrinkage even if no coal gas is adsorbing or desorbing. The multi-domain coupling module (1005) for modeling CO₂ injection into a coal bed may be customized to use the fracture pressure and composition together with an extended Langmuir curve parameter model. Pore volume multiplier is constructed from a combination of a compression term and a swelling/shrinkage term, such as

Vₘ=1+C₀(P−P₀)+Cₑ(ε−ε₀)

This approach, due to the computations of ε₀ as described below, does not predict shrinkage/swelling when the gas adsorbed is not changing.

The component strain is then calculated by an extended Langmuir

formula:

$${ɛ}_{k} = {ɛ}_{∞ , k} \frac{{P}_{sorb} {b}_{k} {a}_{k}}{1 + {P}_{sorb} {\sum }_{j} {b}_{j} {a}_{j}} ,$$

where ε_{∞,k} and bₖ are input Langmuir curve parameters for component k, aₖ represent the adsorbed mole fraction and P_{sorb} is the sorption pressure. The sorption pressure is defined as the fracture pressure if there is a free gas-phase; if not a free gas-phase, the sorption pressure is the pressure when the gas phase begins to desorb. The sorption pressure and corresponding equilibrium mole fractions can be calculated and the total strain is calculated by:

In addition, geomechanical processes fundamental to understand and operate CO₂ injection into coal bed with or without enhanced methane production can be expanded and added into the customized multi-domain coupling module (1005).

Furthermore, threshold events relating to rock compaction or fracturing associated with CO₂ injection into a coal bed during the injection stage, risk assessment, or abandonment strategy are addressed by the multi-domain coupling module (1054) for modeling the interaction between the dynamic model (608) and the static model (604).

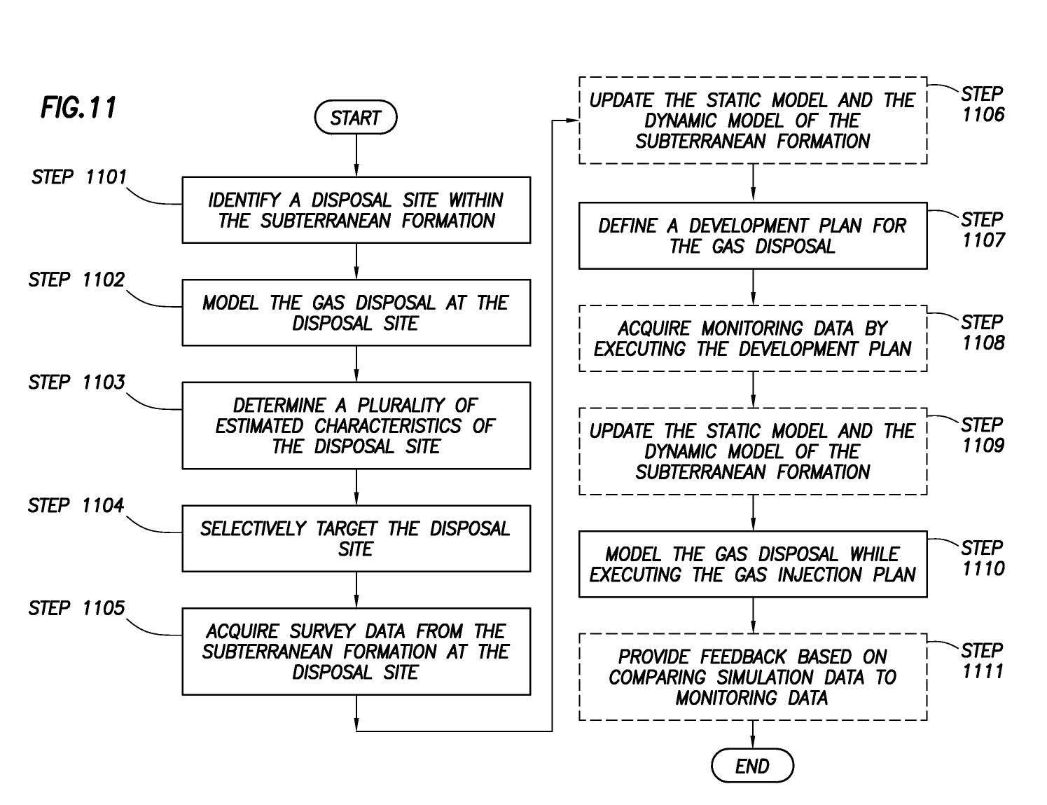

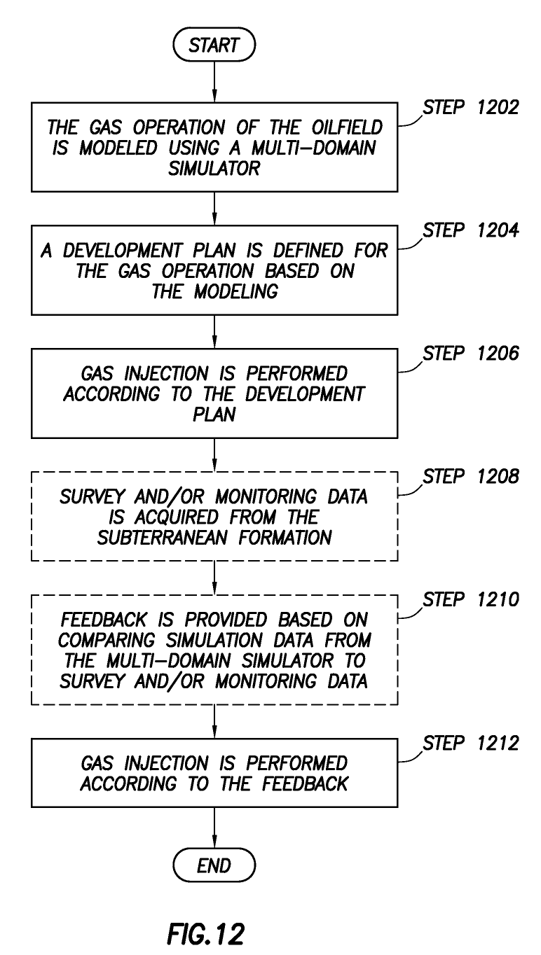

FIGS. 11-12 show exemplary flow charts depicting a method of performing a gas operation. Initially, at least one disposal site within the subterranean formation is identified (Step 1101). The gas disposal at the disposal site is modeled based on simulation using the multi-domain simulator for injecting gas into the subterranean formation (Step 1102). The simulation used is based on the modeling described above in the description related to FIGS. 6-10b.

A plurality of estimated characteristics of the disposal site is determined based on the modeling, where the variety of estimated characteristics include at least one selected from a group including capacity, injectivity, containment, and economics (Step 1103). The disposal site for gas disposal is selectively targeted based on comparing the plurality of estimated characteristics to a pre-determined criteria (Step 1104). This pre-determined criteria may be any appropriate threshold value for one or more of the plurality of estimated characteristics.

Survey data from the subterranean formation may be acquired at the disposal site (Step 1105). The survey data may be acquired in any appropriate manner described above, including both static and real-time acquisition techniques. Next, the static model and the dynamic model of the subterranean formation may be updated (as needed) based on the survey data (Step 1106).

A development plan is defined for the gas disposal according to the model updating, where the development plan includes at least one selected from a group including a well location, a well design, a drilling plan, a gas injection plan, and a monitoring plan (Step 1107).

Optionally, monitoring data may be acquired by executing the development plan (Step 1108). Acquisition of the monitoring data may be performed in a similar manner as described above in relation to FIGS. 1A-1D and 3. The static model and the dynamic model of the subterranean formation may be updated based on the monitoring data (Step 1109).

The gas disposal may be modeled (using the essentially similar techniques as described above) while executing the gas injection plan based on simulation using the static model and the dynamic model of the subterranean formation, and the well model (Step 1110). Feedback may be provided based on comparing simulation data to monitoring data (Step 1111).

The feedback may take any useful tangible form, including storage to a computer readable medium and/or display via a monitor, a printer, or any other display device.

Turning to FIG. 12 shows an exemplary method of performing a gas operation based on using a multi-domain simulator as described in FIGS. 6 and 10A-10B above. Initially, the gas operation of the oilfield is modeled using the multi-domain simulator (Step 1202). The multi-domain simulator includes a static model of the subterranean formation, a dynamic model of the subterranean formation, and a well model. Further, the multi-domain simulator models by coupling the static model, the dynamic model, and the well model. The modeling of the gas operation may involve representing an interactive process between a plurality of aspects of the dynamic model and the static model using a plurality of general equations and converting the plurality of general equations into a multi-domain coupling module configured for coupling the static model, the dynamic model, and the well model. The plurality of general equations may be converted into an explicit expression in the multi-domain coupling module to circumvent a large scale iterative calculation. The dynamic model may include a chemistry aspect, a transport aspect, a mechanic aspect, and/or a heat aspect. The static model may include a petrophysics aspect, a geophysics/seismic aspect, and/or a geology aspect.

Next, a development plan for the gas operation is defined based on the modeling (Step 1204). At this point, gas injection may be performed according to the development plan (Step 1206).

Further, survey and/or monitoring data is acquired from the subterranean formation (Step 1208) and feedback is provided based on comparing simulation data from the multi-domain simulator to the survey and/or monitoring data (Step 1210). Finally, gas injection is performed according to the feedback (Step 1212). This survey and/or monitoring data may be acquired while executing the development plan mentioned in Step 1206 or at any time in the gas operation. Although not shown, economic and/or risk assessment may also be determined during the gas operation.

It will be understood from the foregoing description that various modifications and changes may be made in the preferred and alternative embodiments of the present invention without departing from its true spirit. For example, the modeling modules included herein may be manually and/or automatically activated to perform the desired function. The activation may be performed as desired and/or based on data generated, conditions detected and/or analysis of results from gas injection operations. The processes in the multiple aspects may be of various spatial scales (microscopic or macroscopic) and temporal scales (seconds to minutes or decades).

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

What is claimed is:

1. A method of performing a gas operation of an oilfield having a subterranean formation with at least one reservoir positioned therein, the method comprising:
modeling the gas operation of the oilfield using a multi-domain simulator by coupling a static model of the subterranean formation, a dynamic model of the subterranean formation, and a well model, wherein the multi-domain simulator comprises the static model, the dynamic model, and the well model;
defining a development plan for the gas operation based on the modeling; and
performing gas injection according to the development plan.

2. The method of claim 1, further comprising:
determining a plurality of estimated characteristics of the oilfield based on the modeling, wherein the plurality of estimated characteristics comprises at least one selected from a group consisting of capacity, injectivity, containment, and economics; and
selectively targeting the oilfield for the gas operation based on comparing the plurality of estimated characteristics to a pre-determined criteria.

3. The method of claim 1, further comprising:
performing risk assessment based on the modeling;
performing economic assessment based on the modeling; and
performing shut down/retirement based on the modeling.

4. The method of claim 1,
wherein the oilfield comprises at least one selected from a group consisting of saline aquifer, brine reservoir, hydrocarbon reservoir, fluid body, and geological cavity,
wherein the gas operation comprises disposing gas in at least one selected from a group consisting of gaseous phase, liquid phase, and hydrate, and
wherein disposing gas comprises at least one selected from a group consisting of permanent disposal and temporary storage for later production.

5. The method of claim 1, wherein modeling the gas operation comprises:
representing an interactive process between a plurality of aspects of the dynamic model and the static model using a plurality of general equations; and
converting the plurality of general equations into a multi-domain coupling module configured for coupling the static model, the dynamic model, and the well model.

6. The method of claim 5, wherein the plurality of general equations is converted into an explicit expression in the multi-domain coupling module to circumvent a large scale iterative calculation.

7. The method of claim 5, wherein the dynamic model comprises at least one selected from a group consisting of a chemistry aspect, a transport aspect, a mechanic aspect, and a heat aspect.

8. The method of claim 5, wherein the static model comprises at least one selected from a group consisting of a petrophysics aspect, a geophysics/seismic aspect, and a geology aspect.

9. A method of performing a gas operation of an oilfield having a subterranean formation with at least one reservoir positioned therein, the method comprising:
modeling the gas operation of the oilfield using a multi-domain simulator by coupling a static model of the subterranean formation, a dynamic model of the subterranean formation, and a well model, wherein the multi-domain simulator comprises the static model, the dynamic model, and the well model;
acquiring at least one selected from a group consisting of survey data and monitoring data from the subterranean formation;
providing a feedback based on comparing simulation data from the multi-domain simulator to the at least one selected from a group consisting of survey data and monitoring data; and
performing the gas operation according to the feedback.

10. The method of claim 9, further comprising:
determining a plurality of estimated characteristics of the oilfield based on the modeling, wherein the plurality of estimated characteristics comprises at least one selected from a group consisting of capacity, injectivity, containment, and economics; and
selectively targeting the oilfield for gas operation based on comparing the plurality of estimated characteristics to a pre-determined criteria.

11. The method of claim 9, further comprising:
performing a risk assessment based on the modeling.

12. The method of claim 11, wherein the risk assessment is updated based on the feedback.

13. The method of claim 9, further comprising:
performing an economic assessment based on the modeling.

14. The method of claim 13, wherein the economic assessment is updated based on the feedback.

15. The method of claim 9, wherein modeling the gas operation comprises:
representing an interactive process between a plurality of aspects of the dynamic model and the static model using a plurality of general equations; and
converting the plurality of general equations into a multi-domain coupling module configured for coupling the static model, the dynamic model, and the well model.

16. The method of claim 15, wherein the plurality of general equations is converted into an explicit expression in the multi-domain coupling module to circumvent a large scale iterative calculation.

17. The method of claim 15, wherein the dynamic model comprises at least one selected from a group consisting of a chemistry aspect, a transport aspect, a mechanic aspect, and a heat aspect.

18. The method of claim 15, wherein the static model comprises at least one selected from a group consisting of a petrophysics aspect, a geophysics/seismic aspect, and a geology aspect.

19. The method of claim 9, wherein the static model and the dynamic model are updated based on the feedback.

20. A method of performing a gas operation of an oilfield having a subterranean formation with at least one reservoir positioned therein, the method comprising:
modeling the gas operation of the oilfield using a multi-domain simulator by coupling a static model of the subterranean formation, a dynamic model of the subterranean formation, and a well model, wherein the multi-domain simulator comprises the static model, the dynamic model, and the well model;
performing an economic assessment based on the modeling; and
performing the gas operation according to the economic assessment.

21. The method of claim 20, further comprising:
performing a risk assessment based on the modeling.

22. The method of claim 20, wherein modeling the gas operation comprises:
representing an interactive process between a plurality of aspects of the dynamic model and the static model using a plurality of general equations; and
converting the plurality of general equations into a multi-domain coupling module configured for coupling the static model, the dynamic model, and the well model.

23. The method of claim 22, wherein the plurality of general equations is converted into an explicit expression in the multi-domain coupling module to circumvent a large scale iterative calculation.

24. The method of claim 22, wherein the dynamic model comprises at least one selected from a group consisting of a chemistry aspect, a transport aspect, a mechanic aspect, and a heat aspect.

25. The method of claim 22, wherein the static model comprises at least one selected from a group consisting of a petrophysics aspect, a geophysics/seismic aspect, and a geology aspect.

26. A computer readable medium, embodying instructions executable by a computer to perform method steps for a gas operation of an oilfield having a subterranean formation with at least one reservoir positioned therein, the instructions comprising functionality to:
model the gas operation of the oilfield using a multi-domain simulator by coupling a static model of the subterranean formation, a dynamic model of the subterranean formation, and a well model, wherein the multi-domain simulator comprises the static model, the dynamic model, and the well model;
define a development plan for the gas operation based on the modeling; and
perform gas injection according to the development plan.

27. The computer readable medium of claim 26, the instructions further comprising functionality to:
perform an economic assessment based on the modeling.

28. A computer readable medium, embodying instructions executable by a computer to perform method steps for a gas operation of an oilfield having a subterranean formation with at least one reservoir positioned therein, the instructions comprising functionality to:
model the gas operation of the oilfield using a multi-domain simulator by coupling a static model of the subterranean formation, a dynamic model of the subterranean formation, and a well model, wherein the multi-domain simulator comprises the static model, the dynamic model, and the well model;
acquire at least one selected from a group consisting of survey data and monitoring data from the subterranean formation;
provide a feedback based on comparing simulation data from the multi-domain simulator to the at least one selected from a group consisting of survey data and monitoring data; and
perform the gas operation according to the feedback.

29. The computer readable medium of claim 28, the instructions further comprising functionality to:
perform an economic assessment based on the modeling.

30. The computer readable medium of claim 29, wherein the economic assessment is updated based on the feedback.
